(19) United States
(12) Patent Application Publication
(10) Pub. No.: US 2016/0306197 A1
(43) Pub. Date: Oct. 20, 2016

(54) WINDPROOF GLASS FRAME WITH VENTILATION STRUCTURE

(71) Applicant: LIN-YUN CHEN, TAINAN CITY 704 (TW)

(72) Inventor: LIN-YUN CHEN, TAINAN CITY 704 (TW)

(21) Appl. No.: 14/687,964

(22) Filed: Apr. 16, 2015

(51) Int. Cl. G02C 11/08; G02C 5/14; G02C 5/00

(52) U.S. Cl. CPC G02C 11/08; G02C 5/001; G02C 5/146

(57) ABSTRACT

A windproof glass frame with a ventilation structure includes a glass frame having a rear side facing a face of a user wearing the windproof glass frame. The glass frame includes a lens frame corresponding to an eye portion of the user. The lens frame has two frame sections symmetric to each other. Each of the two frame sections includes at least one vent. An opening/closing mechanism is mounted to each of the two frame sections. Each opening/closing mechanism can be operated to control opening and closing of the at least one vent.

### BACKGROUND OF THE INVENTION

The present invention relates to windproof glasses and, more particularly, to a windproof glass frame with a ventilation structure.

Aside from eyesight correction, glasses, such as sunglasses or sport glasses, can provide functions of blocking bright lights, filtering blue lights and ultraviolent lights, and protecting the eyes. Sport glasses or windproof glasses can prevent flying sands, dusts, or other impurities from entering and injuring the eyes during outdoor activities. The frame of sport glasses or windproof glasses can contact the face of the user more snugly than ordinary glasses to reduce the air currents passing through the eyes, reducing occurrence of sands entering the eyes.

Although the sand shielding effect can be increased when the frame snugly contracts the face of the user, air currents cannot pass easily, leading to difficulties in dissipation of hot air and sweat at the inner side of the glasses. Thus, the inner faces of the lenses are apt to be fogged when the hot air vaporizes between the glasses and the face of the user, which adversely affects the vision and which could be dangerous during outdoor activities. Furthermore, the frame is apt to be moistened by the sweat that is difficult to dry by air, such that the frame stinks easily. To avoid the disadvantages. windproof glasses including a frame with a plurality of vents have been proposed. The space at the inner side of the glasses intercommunicates with the outside via the vents to dissipate the hot air and moisture at the inner side of the lenses, reducing the chance of fogging of the lenses.

However, when the windproof glasses with vents are used in an environment of strong winds and sands, sands can flow along with the strong air currents through the vents into the space at the inner side of the glasses, causing injury to the eyes of the user.

Thus, a need exists for a novel windproof glass frame that can control opening and closing of vents in response to different environments.

### BRIEF SUMMARY OF THE INVENTION

A windproof glass frame with a ventilation structure according to the present invention includes a glass frame having a rear side. The rear side is adapted to face a face of a user wearing the windproof glass frame. The glass frame includes a lens frame corresponding to an eye portion of the user. The lens frame has two frame sections symmetric to each other. Each of the two frame sections includes at least one vent. An opening/closing mechanism is mounted to each of the two frame sections. Each opening/closing mechanism can be operated to control opening and closing of the at least one vent.

Each opening/closing mechanism can include a track groove disposed along one of the two frame sections. Each opening/closing mechanism can further include a cover plate received in the track groove thereof. Each cover plate is slideable in one of the track grooves to cover or open the at least one vent of one of the two frame sections.

In an embodiment, the at least one vent of each of the two frame sections includes a plurality of vents. Each cover plate includes a plurality of through-holes corresponding to the plurality of vents. Each cover plate includes a covering section without the plurality of through-holes. Each cover plate is slideable between a first position in which the plurality of through-holes is aligned with the plurality of vents and a second position in which the covering section covers the plurality of vents.

Each of the two frame sections can include a panel in which the plurality of vents is defined. A fixing seat is fixed to a rear side of each panel. Each track groove is defined by one of the panels and one of the fixing seat. Each fixing seat includes a plurality of holes corresponding to the plurality of vents. Each fixing seat further includes an elongated hole. A push rod extends through the elongated hole of each fixing seat and has a first end fixed to one of the cover plates and a second end located outside of the fixing seat. The second end of each push rod is adapted to be operated to move the push rod in the elongated hole of one of the fixing seats, thereby moving one of the cover plates along one of the track grooves.

Each elongated hole includes an intermediate portion having a neck between two ends of the elongated hole. The neck has a width smaller than a width of a corresponding push rod. Each push rod is positioned in one of the two ends of one of the elongated holes to fix one of the cover plates in one of the first and second positions. Each push rod is made of elastic material and is operable to forcibly pass through the neck of one of the elongated holes.

The windproof glass frame can further include a soft pad mounted to a rear side of the lens frame. The soft pad can include a recessed portion.

The present invention will become clearer in light of the following detailed description of illustrative embodiments of this invention described in connection with the drawings.

### DESCRIPTION OF THE DRAWINGS

FIG. 1 is a perspective view of a windproof glass frame with a ventilation structure according to the present invention.

FIG. 2 is an exploded, perspective view of the windproof glass frame according to the present invention.

FIG. 3 is a partial, perspective view illustrating an opening/closing mechanism and a portion of the windproof glass frame according to the present invention.

FIG. 4 is a cross sectional view of a portion of the windproof glass frame according to the present invention, with vents of the windproof glass frame opened.

FIG. 5 is a view similar to FIG. 4, with the vents of the windproof glass frame covered.

FIG. 6 is a rear, perspective view of a windproof glass frame with a ventilation structure of another embodiment according to the present invention, with the windproof glass frame having a soft pad.

### DETAILED DESCRIPTION OF THE INVENTION

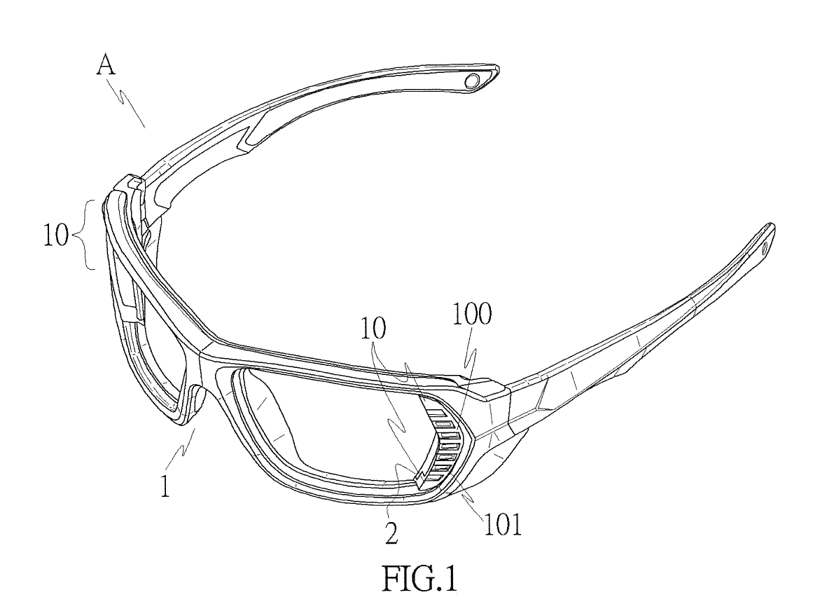

With reference to FIG. 1, a windproof glass frame with a ventilation structure according to the present invention include a glass frame A. The glass frame A is a windproof frame that can contact a face of a user more snugly than ordinary glasses frames to prevent winds and sands from entering the eyes of the user. The glass frame A includes a rear side adapted to face a face of a user wearing the windproof glass frame. The glass frame A further includes a front side opposite to the rear side. Furthermore, the glass frame A includes a lens frame 1 corresponding to the eye portion of the user. Lenses can be mounted to the lens frame 1. The lens frame 1 has two frame sections 10 symmetric to each other. Each of the two frame sections 10 includes at least one vent 101. An opening/closing mechanism 2 is mounted to each of the two frame sections 10. Each opening/closing mechanism 2 can be operated to control opening and closing of the at least one vent 101. In this embodiment, each frame section 10 includes a plurality of vents 101 arranged in a grid manner to provide enhanced ventilation effect. The two frame sections 10 are two symmetric sections of the lens frame 1. In this embodiment, the two frame sections 10 are located in left and right ends of the lens frame 1, such that air currents passing through the vents 101 will not pass through the eyes of the user, preventing the eyes from becoming dry and preventing winds and sands from entering the eyes. However, the two frame sections 10 can be located in other sections of the lens frame 1, as long as the two frame sections 10 are symmetric to each other.

The vents 101 provide the space between the glass frame A and the eye portion of the user with a better ventilation effect to dissipate the hot air between the glass frame A and the eye portion, avoiding the inner faces of the lenses from fogging. By provision of the opening/closing mechanisms 2, the vents 101 can be opened or closed according to the needs of the user. As an example, in an environment of strong winds and sands, the opening/closing mechanisms 2 can be operated to close the vents 101, preventing winds and sands from entering the eyes via the vents 101.

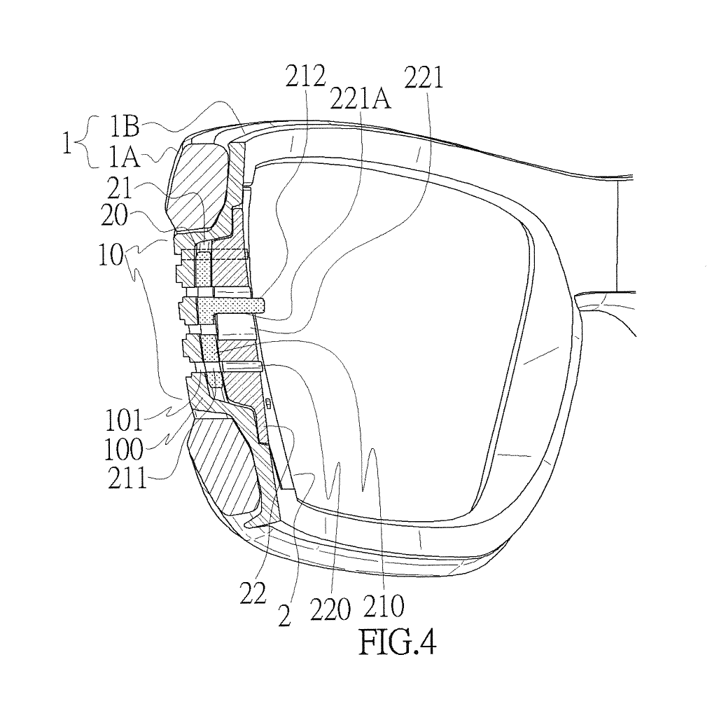

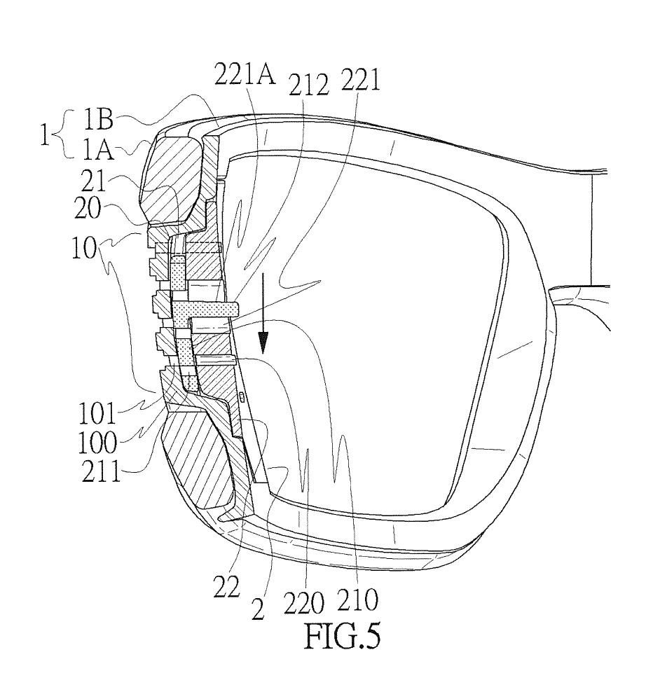

With reference to FIGS. 4 and 5, each opening/closing mechanism 2 includes a track groove 20 disposed along one of the two frame sections 10. Each opening/closing mechanism 2 further includes a cover plate 21 received in the track groove 20 thereof. Each cover plate 21 can slide in one of the track grooves 20 to cover or open the vents 101 of one of the two frame sections 10.

In this embodiment, each cover plate 21 includes a plurality of through-holes 211 corresponding to the vents 101. Each cover plate 21 includes a covering section 210 without the through-holes 211. Each cover plate 21 can slide between a first position in which the through-holes 211 are aligned with the vents 101 and a second position in which the covering section 210 covers the vents 101. Thus, if it is desired to open the vents 101, each cover plate 21 is in the first position in which the through-holes 211 are aligned with the vents 101. If it is desired to close the vents 101, each cover plate 21 is moved to the second position to cover the vents 101 with the covering section 210. By such an arrangement, opening and closing of the vents 101 can be achieved through movement of each cover plate 21 in a short distance.

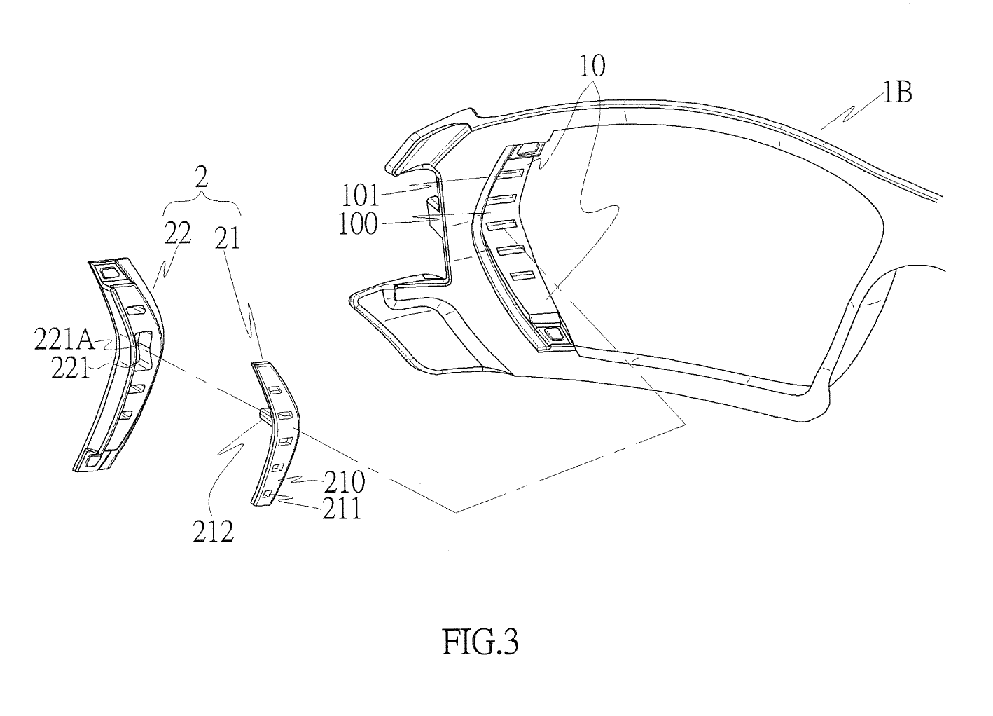

With reference to FIGS. 3-5, each of the two frame sections 10 includes a panel in which the vents 101 are defined. A fixing seat 22 is fixed to a rear side of each panel 100. Each track groove 20 is defined by one of the panels 100 and one of the fixing seat 22. Each fixing seat 22 includes a plurality of holes 220 corresponding to the vents 101, such that the holes 220 are aligned with the vents 101 in the open position.

Each fixing seat 22 further includes an elongated hole 221. A push rod 212 extends through the elongated hole 221 of each fixing seat 22 and has a first end fixed to one of the cover plates 21 and a second end located outside of the fixing seat 22. The second end of each push rod 212 is adapted to be operated to move the push rod 212 in the elongated hole 221 of one of the fixing seats 22, thereby moving one of the cover plates 21 along one of the track grooves 20. In this embodiment, the elongated hole 221 is defined in a rear side of the fixing seat 22. When the vents 101 are in the open position, the elongated holes 221 are in communication with some of the vents 101. Note that the locations of the elongated holes 221 and the push rods 212 are not limited to the embodiment shown. Other forms of holes 2210 intercommunicated with the track grooves 20 and permitting the push rods 212 to extend out of the fixing seats 22 can be used.

Since each panel 100 and one of the fixing seats 22 together define a reliable track groove 20, the cover plates 21 are less likely to fall off due to wear of components. By the provision of the elongated holes 221 and the push rods 212 operably connected to the cover plates 21, opening and closing of the vents 101 can easily be achieved by the cover plates 21 that can be moved by simply moving the exposed push rods 212. Thus, the opening/closing process is simple and rapid.

In this embodiment, each elongated hole 221 includes an intermediate portion having a neck 221A between two ends of the elongated hole 221. The neck 221A has a width smaller than a width of the corresponding push rod 21. Each push rod 212 can be positioned in one of the two ends of one of the elongated holes 221 to fix one of the cover plates 21 in one of the first and second positions corresponding to opening and closing of the vents 101. Each push rod 212 is made of elastic material (such as plastic or rubber) and can be operated to forcibly pass through the neck 221A of one of the elongated holes 221.

Specifically, since the width of the neck 221A in each elongated hole 221 is smaller than the corresponding push rod 212, the push rod 212 can be retained in one of the ends of the elongated hole 221 above the neck 221A to fix the corresponding cover plate 21 in the first position in which the vents 101 are open. On the other hand, if the push rod 212 is retained in the other end of the elongated hole 221 below the neck 221A, the corresponding cover plate 21 is in the second position in which the vents 101 are covered. Since the push rods 212 are made of elastic material (such as plastic), an external force can be applied to forcibly move each push rod 212 through the corresponding neck 221A, switching the vents 101 between the open state and the closed state.

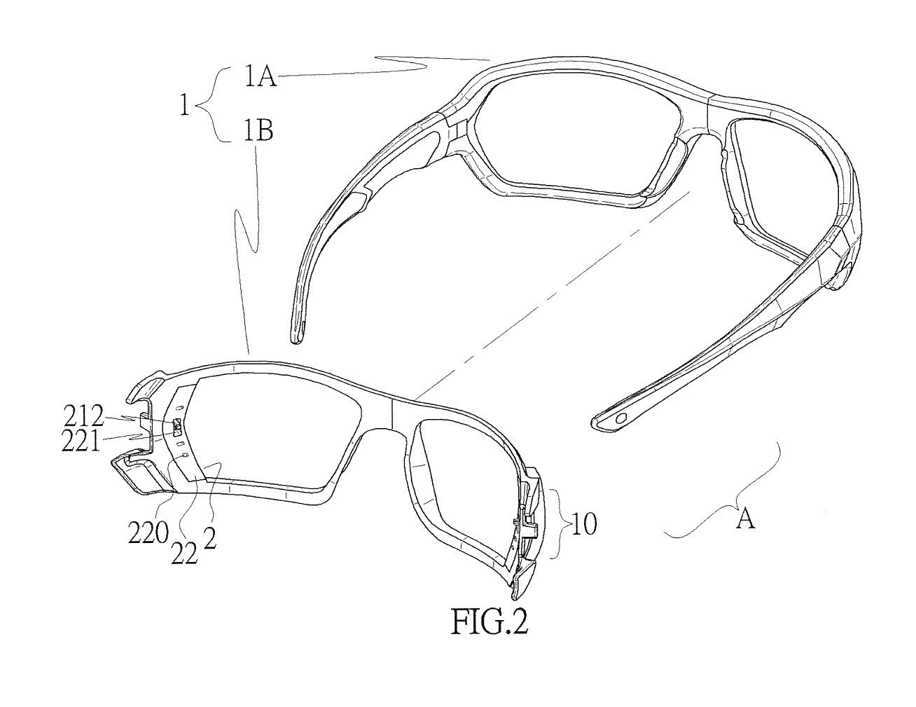

With reference to FIG. 2, the lens frame 1 includes a main frame 1A and a pad frame 1B inserted into a rear side of the main frame 1A. The panels 100 and the pad frame 1B are integrally connected with each other. Thus, each panel 100 and the corresponding opening/closing mechanism 2 (including the cover plate 21 and the fixing seat 22) can be detached along with the pad frame 1B from the main frame 1A.

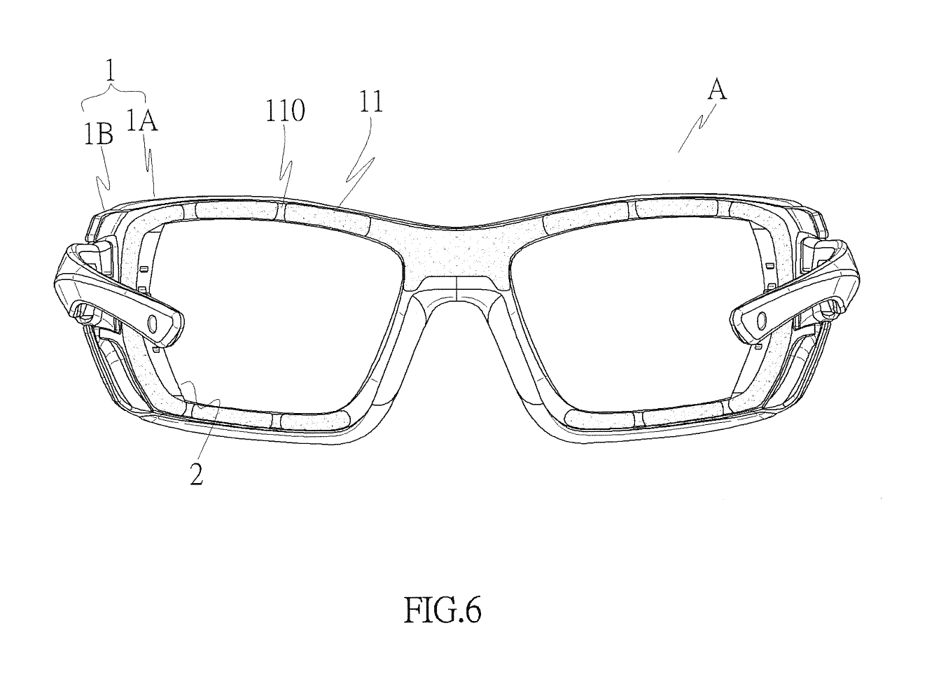

With reference to FIG. 6, a soft pad 11 can be mounted to a rear side of the lens frame 1. In this embodiment, the soft pad 11 is mounted to the pad frame 1B to permit easy removal of the soft pad 11 that is worn or deteriorates. The soft pad 11 provides a comfort feeling when the lens frame 1 contacts the face of the user. The soft pad 11 can include a plurality of recessed portions 110 for air convention with the vents 101, increasing the ventilation of the present invention.

Although specific embodiments have been illustrated and described, numerous modifications and variations are still possible without departing from the scope of the invention. The scope of the invention is limited by the accompanying claims.

1. A windproof glass frame with a ventilation structure, comprising a glass frame including a rear side, with the rear side adapted to face a face of a user wearing the windproof glass frame, with the glass frame including a lens frame corresponding to an eye portion of the user, with the lens frame having two frame sections symmetric to each other, with each of the two frame sections including at least one vent, with an opening/closing mechanism mounted to each of the two frame sections, and with each opening/closing mechanism operable to control opening and closing of the at least one vent.

2. The windproof glass frame with a ventilation structure as claimed in claim 1, with each opening/closing mechanism including a track groove disposed along one of the two frame sections, with each opening/closing mechanism further including a cover plate received in the track groove thereof, and with each cover plate slideable in one of the track grooves to cover or open the at least one vent of one of the two frame sections.

3. The windproof glass frame with a ventilation structure as claimed in claim 2, with the at least one vent of each of the two frame sections including a plurality of vents, with each cover plate including a plurality of through-holes corresponding to the plurality of vents, with each cover plate including a covering section without the plurality of through-holes, and with each cover plate slideable between a first position in which the plurality of through-holes is aligned with the plurality of vents and a second position in which the covering section covers the plurality of vents.

4. The windproof glass frame with a ventilation structure as claimed in claim 3, with each of the two frame sections including a panel, with the plurality of vents defined in the panel, with a fixing seat fixed to a rear side of each panel, with each track groove defined by one of the panels and one of the fixing seat, with each fixing seat including a plurality of holes corresponding to the plurality of vents, with each fixing seat further including an elongated hole, with a push rod extending through the elongated hole of each fixing seat and having a first end fixed to one of the cover plates and a second end located outside of the fixing seat, and with the second end of each push rod adapted to be operated to move the push rod in the elongated hole of one of the fixing seats, thereby moving one of the cover plates along one of the track grooves.

5. The windproof glass frame with a ventilation structure as claimed in claim 4, with each elongated hole including an intermediate portion having a neck between two ends of the elongated hole, with the neck having a width smaller than a width of a corresponding push rod, with each push rod positioned in one of the two ends of one of the elongated holes to fix one of the cover plates in one of the first and second positions, and with each push rod made of elastic material and operable to forcibly pass through the neck of one of the elongated holes.

6. The windproof glass frame with a ventilation structure as claimed in claim 1, further comprising a soft pad mounted to a rear side of the lens frame.

7. The windproof glass frame with a ventilation structure as claimed in claim 6, wherein the soft pad includes a recessed portion.
